(19) United States
(12) Patent Application Publication
(10) Pub. No.: US 2024/0307962 A1
(43) Pub. Date: Sep. 19, 2024

(54) ROOM TEMPERATURE FLEXIBLE UV CURABLE RESIN AND METAL FILLED COMPOSITE FILAMENT FOR FUSED FILAMENT FABRICATION PRINTING

(71) Applicant: 3DFoundri, Inc., East Lansing, MI (US)

(72) Inventors: Kenneth L Foster, Brighton, MI (US); Hoa Xuan Nguyen, San Jose, CA (US)

(73) Assignee: 3DFoundri, Inc., East Lansing, MI (US)

(21) Appl. No.: 18/603,748

(22) Filed: Mar. 13, 2024

Related U.S. Application Data
(60) Provisional application No. 63/489,942, filed on Mar. 13, 2023.

(51) Int. Cl. B22F 10/18; B22F 3/10; B22F 10/64; B28B 1/00; B33Y 10/00; B33Y 40/20

(52) U.S. Cl. CPC B22F 10/18; B22F 3/1021; B22F 10/64; B28B 1/001; B33Y 10/00; B33Y 40/20; B22F 2998/10

(57) ABSTRACT

A three-dimensional metal printing process includes forming a melt mix of a thermoplastic curable polymer resin with particles of metal, ceramic, or both. The melt mix is fed into an extruder forming a composite filament mixture. The composite filament mixture is fed into a fused filament fabrication printer configured to deposit layers onto a printing surface for building a desired shape. The layers of the composite filament form a green part and are cured by a UV source as the layers are deposited. A thermal de-binding of the green part occurs to remove the thermoplastic cured polymer resin and allows the mixture of metal or ceramic particles to set and hold shape as a metal skeleton structure. The metal skeleton is then sintered forming a metal part.

### CROSS-REFERENCE TO RELATED APPLICATIONS

Priority is claimed to U.S. Provisional Application No. 63/489,942 filed Mar. 13, 2023, which is incorporated herein by reference in its entirety.

### TECHNICAL FIELD

The present disclosure relates generally to three-dimensional (3D) printing of metal components.

### BACKGROUND

Three-dimensional (“3D”) printing is rapidly advancing field of technology. Filaments have been used for 3D printing such as those disclosed in US20210122911A1 by Roch et al, which is incorporated by reference herein. 3D printing streamlines manufacturing by allowing designs with multiple parts manufactured in a single part often referred to as additive manufacturing (“AM”). Traditionally, 3D printing filaments are brittle and if the filaments include an additive filler, it can be challenging or impossible to feed it into a printing head. Attempts have been made to create a 3D printable filament having a filler yet has the strength and flexibility to maintain a desired manufactured shape and dimensions during sintering and debinding. However, these attempts have led to parts that are susceptible to bloating, sagging, and deformation.

Attempts have been made to reinforce filaments by adding binders, often wax. However, these binders require additional processing such as solvent extractions. A need remains for a curable resin and metal or ceramic filled composite filament that is flexible at room temperature.

### BRIEF SUMMARY

In one aspect, a three-dimensional (3D) metal printing process includes a) forming a melt mix of a thermoplastic curable polymer resin with particles of metal, ceramic, or both, b) forming a composite filament mixture of the melt mix by feeding the melt mix into an extruder, where the composite filament mixture is configured to be flexible at room temperature, c) feeding the composite filament mixture into an fused filament fabrication (FFF) printer configured to deposit layers of the composite filament mixture onto a printing surface for building a desired or preprogrammed shape, where the layers of the composite filament form a green part, d) curing with a source of UV light the deposited layers of the composite filament as the deposited layers are formed, and e) thermally de-binding the green part to remove the thermoplastic cured polymer resin and allowing the mixture of metal or ceramic particles to set and hold shape as a metal skeleton structure. The 3D metal printing process may further include the step of sintering the metal skeleton structure into a metal part.

The metal particles can be selected from the group consisting of stainless steel, steel alloys, copper, aluminum, nickel, zinc, and combinations thereof. The melt mix can be pelletized into a plurality of pellets.

In an example, the extruder receives the melt mix from a hopper through a funnel into a barrel defining a passage, and at least one screw is provided in the passage coupled to a motor and the at least one screw drives the pellets in a longitudinal direction through the passage towards a die and heats the melt mix to form the filament mixture.

The composite filament mixture can be fed by a pair of traction wheels into an extrusion head and then through at least one heater before being deposited onto a printing surface. The thermoplastic curable polymer resin can be filled to at least 45% by volume loading of the metal or ceramic particles during the formation of the melt mix, and alternatively to at least 55% by volume loading of the metal or ceramic particles, and even still to at least 60% by volume loading of the metal or ceramic particles.

The forming of the melt mix may include loading of the metal or ceramic between 85% and 95% by weight in the composite filament mixture. The melt mix may further include additives and/or sintering aides. The sintering step initiates necking of the metal and/or ceramic particles. The process may also include the step of removing excess material and/or polishing the metal part.

The passage within the barrel can be a cylindrical passage. The melt mix is driven through the passage by the screw thereby increasing pressure within the passage and increasing temperature thereby further mixing the materials of the melt mix.

In another example, the composite filament mixture passes through a plurality of heaters before being deposited onto a printing surface. The at least one heater or the plurality of heaters can be configured to be heated to a temperature between 40° C. to 230° C.

The 3D metal printing process may further include additives such as adhesion promotors for resin to metal surfaces or steric acid to increase the loading of metal particles. The additives may also include plasticizers configured to add free volume to the resin and manipulate glass transition temperatures for enhanced mixing or FFF printing. In an example, the plasticizers can be selected from the group consisting of adipates, azelates, citrates, benzoates, ortho-phthalates, terephthalates, sebacates, tributyl citrate, trimellitates, and combinations thereof. Other technical features may be readily apparent to one skilled in the art from the following figures, descriptions, and claims.

For purposes of summarizing the disclosure, certain aspects, advantages, and novel features of the disclosure have been described herein. It is to be understood that not necessarily all such advantages may be achieved in accordance with any one particular embodiment of the disclosure. Thus, the disclosure may be embodied or conducted in a manner that achieves or optimizes one advantage or group of advantages as taught herein without necessarily achieving other advantages as may be taught or suggested herein. The features of the disclosure which are believed to be novel are particularly pointed out and distinctly claimed in the concluding portion of the specification. These and other features, aspects, and advantages of the present disclosure will become better understood with reference to the following drawings and detailed description.

### BRIEF DESCRIPTION OF THE DRAWINGS

The figures which accompany the written portion of this specification illustrate embodiments and method(s) of use for the present disclosure constructed and operative according to the teachings of the present disclosure.

FIG. 1 illustrates an example schematic of a polymer thermal melt extruder with die according to the present disclosure.

FIG. 2 illustrates a schematic of an example Fused Filament Fabrication (FFF) Printer according to the present disclosure.

FIG. 3 illustrates a process flow chart for 3D printing of metal parts in accordance with the present disclosure.

FIG. 4 illustrates a magnified image of copper particles with fully formed necks.

FIG. 5 illustrates an example schematic group of particles progressing through a necking process.

The various embodiments of the present disclosure will hereinafter be described in conjunction with the appended drawings, wherein like designations denote like elements.

### DETAILED DESCRIPTION

The present disclosure provides for a room temperature flexible UV curable resin and metal or ceramic filled composite filament and systems and methods related to making using the composite filament. The composite filament can be formed into a uniform diameter filament and printed on traditional FFF (fused filament fabrication) printers. Each layer is exposed to UV light to cure a photopolymer and lock in a shape as a part is being printed. This occurs throughout the later stages of thermal process steps to convert to a full metal part and preserve a desired 3D shape.

Conventional metal filled filaments can be very brittle and typically not loaded as high as desired. Higher loading results in substantially lower shrinkage upon debinding and sintering. Filaments with metal filler may also sag during thermal sintering steps and often require extra supports that later must be removed. Extra supports require additional resources like additional printing time and increased material cost to produce a desired part.

Due to the fragility of current filaments, manufacturers have added small ovens above printers to prevent the filament from breaking during printing. However, this fails to solve other problems like filaments breaking on a spool at some unknown location during shipping. Current methods also require a solvent debinding step to remove lower viscosity waxes added to a thermoplastic resin to aide in debinding. This requires an additional expensive processing step. Eliminating this solvent debinding step allows a thermal debinding process step that leads into sintering to occur in the same oven. Solvent debinding also requires more supports that must be removed during post processing adding additional cost.

The present disclosure provides for a suitable loading of metal in resin to achieve a desired result. In an example, the loading is above 45 vol %, or above 50 vol % and still further above 60 vol % up to theoretical loading near low to mid 60 vol % (e.g., between 60 vol % and 65 vol %). The loading may vary with particle size distribution, mean particle size, and even metal used. Metal loadings can be between 85% to 94% by weight metal in the composite and include sintering aides (e.g., boron and other boron compounds may lower melting temperature at a metal's surface so it will fuse easier and more completely). The metal particles may include, but are not limited to, stainless steel and other steel grades and alloys, copper, aluminum, nickel, zinc or the like. In an example, additional additives may be included such as adhesion promotors for resin to metal surfaces or steric acid to increase the loading of metal particles.

Additionally, in some examples, plasticizers are used to add free volume to the resin and manipulate the glass transition temperature for improving component mixing or FFF printing. Examples of plasticizers used may include, but are not limited to, esters such as adipates, azelates, citrates, benzoates, ortho-phthalates, terephthalates, sebacates, tributyl citrate, and trimellitates.

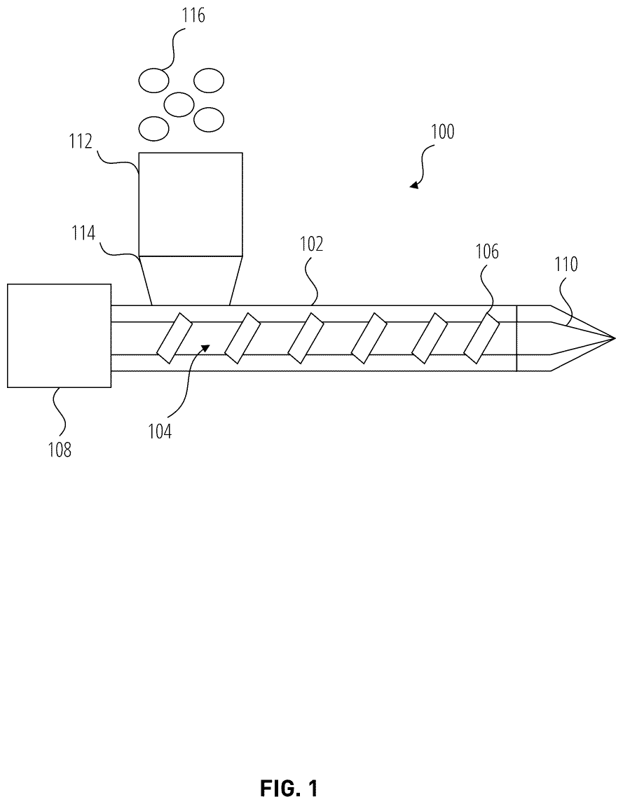

Referring to FIG. 1 to FIG. 5, the present disclosure provides for a filament composite and system and method of use for 3D printing a metal and/or a composite part. In this example, the system and method includes converting a mixture of resin, metal or ceramic particles, and optional additives, into a final printed metal part.

FIG. 1 illustrates a single screw melt extruder 100 according to the present disclosure. Extruder 100 includes a barrel 102 defining a longitudinal cylindrical passage 104 having a screw 106 therein extending from a motor 108 to a die 110. A hopper 112 is connected to a funnel 114 that feeds into barrel 102. Filament mixture 116 is fed into hopper 112. A melt mix of UV curable thermoplastic resin and metal or ceramic filled particles is prepared and provided as filament mixture 116 in this example. The filament mixture 116 is fed through hopper 112 and deposited into barrel 102 by funnel 114. Cylindrical passage 104 extends through the length of the barrel 102 in a longitudinal direction driving the filament mixture 116 into die 110 by screw 106.

Once the filament mixture 116 enters barrel 102, a motor 108 begins to drive the screw 106. The rotation of screw 106 pushes the material in the longitudinal direction down the cylindrical passage 104 toward an opposite end. The filament mixture 116 is subjected to high pressure, which in turn heats and melts the filament mixture 116 and mixes the thermoplastic resin and the metal or ceramic filled particles into a melt mix. Screw 106 continues to push the melt mix longitudinally toward a die 110 arranged at an opposite end of barrel 102. The die 110 shapes the melt mix into a uniform width before it is extruded out the die 110 forming a filament.

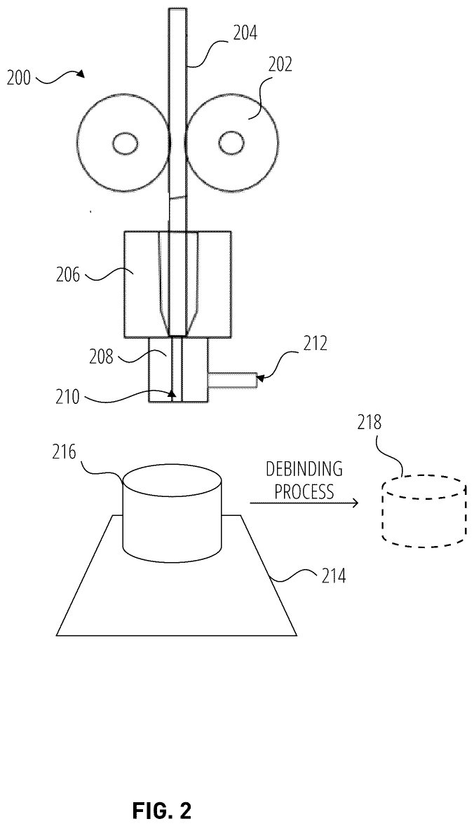

Referring to FIG. 2, the filament from FIG. 1 can then be fed into a 3D-FFF printer 200. In this example, 3D-FFF printer 200 is schematically shown having a pair of traction wheels 202 with an example filament 204 passing therethrough. Filament 204 is fed by the traction wheels 202 into an extrusion head 206 and then heated by heater 208 when passing through a heating passage 210. A UV source 212 is provided to cure filament 204 as it exits the heater 208 and forms layers deposited onto printing surface 214 to form a green part 216. The formulation for filament 204 includes metal or ceramic particles in a polymer matrix and optionally other additives and manufactured for use in 3D-FFF printer 200.

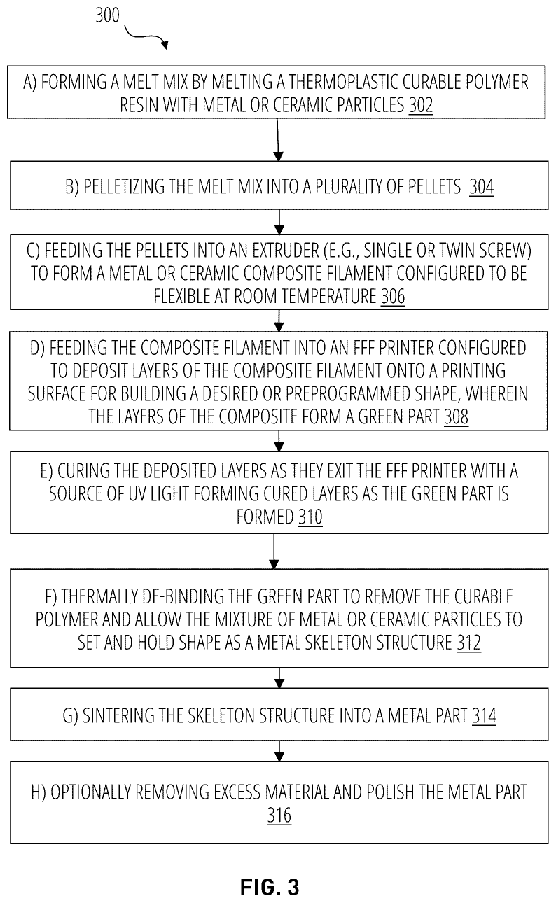

Referring to FIG. 1, FIG. 2, and FIG. 3, the present disclosure provides for an example 3D-printing process 300. In a first step 302, a filament mixture (e.g., filament mixture 116) is melt mixed in an extruder 100 to mix the components. The extruder may be a twin or single screw extruder. FIG. 1 illustrates a single screw extruder 100.

In a second step 304, the extruded melt mix is cut into pellets of uniform size and shape.

In a third step 306, the pellets formed by the extruder 100 may be further processed by introducing them again into extruder 100 in the same manner described above. This third step 306 of processing the filament mixture 116 into a second melt mixture has an advantage of ensuring a more through mixture of the thermoplastic resin and the metal or ceramic particles. As the second melt mixture is extruded out the die 110, it forms a composite filament 204 that remains flexible at room temperature, for use in 3D-FFF printer 200.

In an example, during the melt mixing, the resin can be a thermoplastic and filled to 45% by volume loading or more of metal or ceramic particles. In another example, the resin is filled to 55 vol % loading or more of metal or ceramic particles. In yet another example, the resin is filled to 60 vol % loading or more of metal or ceramic particles. A range of particle size and distributions can be used depending on desired performance requirements. In addition, additives for rheological control or sintering aides may also be included.

In a fourth step 308, the filament 204 is fed into the 3D-FFF printer 200 to be shaped and extruded. In an example, the 3D-FFF printer 200 is configured to deposit layers of the filament 204 onto the printing surface 214 for building a desired or pre-programmed shape (e.g., a green part 216). Filament 204 is fed by the traction wheels 202 that push filament 204 in a longitudinal direction into extrusion head 206. In this example, extrusion head 206 is tapered in the longitudinal direction which exerts pressure on the filament 204. As the filament 204 is extruded through extrusion head 206, it enters a cylindrical heating passage 210 defined by one or more heaters 208. In an example, the heater(s) 208 are configured to be heated to a temperature between 40° C. to as much as 230° C. depending on the desired outcome and material properties.

In a fifth step 310, filament 204 is pushed through heating passage 210 and extruded out the 3D-FFF printer 200 where a UV source 212 exposes the filament 204 with UV light to cure resin particles. Curing resin particles of each deposited layer and allows the filament 204 to quickly set and maintain its shape through the remainder of the process. Typical UV wavelength ranges from 10 to 400 nm.

The filament 204 is deposited onto the printing surface 214 in a desired 3D shape of a desired green part 216. The green part 216 is the printed 3D shape of a final desired part prior to debinding and sintering. The benefits of the UV source 212 is that by curing the photopolymer resin, the filament 204 can quickly set in the shape of the desired green part 216, thereby providing rigidity and strength without the waste of additional supports.

In a sixth step 312, after green part 216 is fully cured, it advances to a thermal de-binding process to remove organic carbon and allow early stage necking of the metal or ceramic particles. Traditionally, thermal debinding generally requires two steps to remove both a primary and secondary binder. By using an extrudable photopolymer resin as the sole binder of filament 204, it eliminates the need for multi-step thermal debinding, thereby saving time and cost. The sixth step 312 of thermal debinding converts the green part 216 into a metal skeleton structure 218.

In a seventh step 314, thermal sintering converts the metal skeleton structure 218 into a strengthened metal structure. The sintering process is a thermal treatment for bonding particles into a coherent, predominantly solid structure. This bonding leads to improved strength and lower system energy.

In an eighth step 316, the process 300 can include an optional step of removing excess material and polishing the metal part. Completion of this process results in a final 3D printed metal part similar in strength to traditionally molded or cast metal parts.

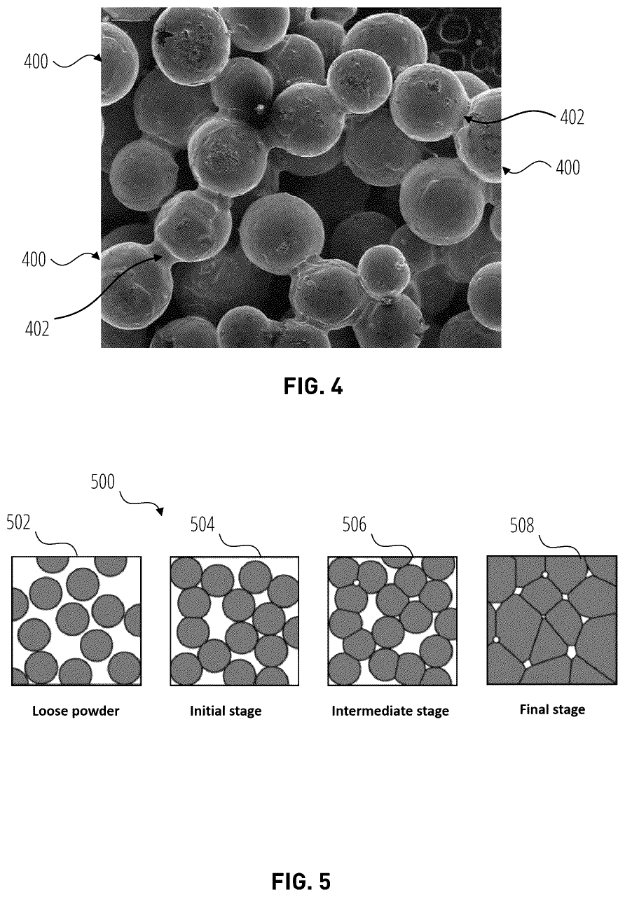

FIG. 4 illustrates a SEM image of example bronze particles 400 with formed solid necks 402 after sintering at 800° C. This demonstrates the particle necking phenomena when heated. The initial stage of sintering (i.e., from the seventh step 314) induces neck 402 formation among the bronze particles 400.

Referring to FIG. 5, the metal or ceramic particles of a final metal structure can go through the entire process, and during sintering, the particles start to “neck” and attach to each other and grow into one single crystal with few defects. FIG. 5 illustrates a schematic progression of particles undergoing the necking process 500. Loose powder is shown in box 502 which advances to an initial stage in box 504 as the particles begin to clump together. At box 506, an intermediate stage is reached where the particles begin to squeeze before the final stage at box 508.

In an example, boron is provided as an additive which helps lower temperature of necking by lowering the eutectic temperature of the metal particle surface making it a more thermodynamic favorable to form single crystal of metal.

It should be noted that the steps described in the method of use can be conducted in many different orders according to user preference. The use of “step of” should not be interpreted as “step for”, in the claims herein and is not intended to invoke the provisions of 35 U.S.C. § 314 (f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the disclosure described herein are exemplary and numerous modifications, variations and rearrangements can be readily envisioned to achieve substantially equivalent results, all of which are intended to be embraced within the spirit and scope of the disclosure. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A three-dimensional (3D) metal printing process comprising:
a) forming a melt mix of a thermoplastic curable polymer resin with particles of metal, ceramic, or both;
b) forming a composite filament mixture of the melt mix by feeding the melt mix into an extruder, wherein the composite filament mixture is configured to be flexible at room temperature;
c) feeding the composite filament mixture into a fused filament fabrication (FFF) printer configured to deposit layers of the composite filament mixture onto a printing surface for building a desired or preprogrammed shape, wherein the layers of the composite filament form a green part;
d) curing with a source of UV light the deposited layers of the composite filament as the deposited layers are formed; and
e) thermally de-binding the green part to remove the thermoplastic cured polymer resin and allowing the mixture of metal or ceramic particles to set and hold shape as a metal skeleton structure.

2. The 3D metal printing process of claim 1, further comprising the step of sintering the metal skeleton structure into a metal part.

3. The 3D metal printing process of claim 2, wherein the sintering step initiates necking of the metal and/or ceramic particles.

4. The 3D metal printing process of claim 2, further comprising the step of removing excess material and/or polishing the metal part.

5. The 3D metal printing process of claim 1, wherein the metal particles are selected from the group consisting of stainless steel, steel alloys, copper, aluminum, nickel, zinc, and combinations thereof.

6. The 3D metal printing process of claim 1, wherein the melt mix is pelletized into a plurality of pellets.

7. The 3D metal printing process of claim 1, wherein the extruder receives the melt mix from a hopper through a funnel into a barrel defining a passage, and at least one screw is provided in the passage coupled to a motor and the at least one screw drives the pellets in a longitudinal direction through the passage towards a die and heats the melt mix to form the filament mixture.

8. The 3D metal printing process of claim 7, wherein the passage is a cylindrical passage.

9. The 3D metal printing process of claim 7, wherein the melt mix is driven through the passage by the screw thereby increasing pressure within the passage and increasing temperature thereby further mixing the materials of the melt mix.

10. The 3D metal printing process of claim 1, wherein the composite filament mixture is fed by a pair of traction wheels into an extrusion head and then through at least one heater before being deposited onto a printing surface.

11. The 3D metal printing process of claim 10, wherein composite filament mixture passes through a plurality of heaters before being deposited onto a printing surface.

12. The 3D metal printing process of claim 10, wherein the at least one heater is configured to be heated to a temperature between 40° C. to 230° C.

13. The 3D metal printing process of claim 1, wherein the thermoplastic curable polymer resin is filled to at least 45% by volume loading of the metal or ceramic particles during the formation of the melt mix.

14. The 3D metal printing process of claim 1, wherein the thermoplastic curable polymer resin is filled to at least 55% by volume loading of the metal or ceramic particles during the formation of the melt mix.

15. The 3D metal printing process of claim 1, wherein the thermoplastic curable polymer resin is filled to at least 60% by volume loading of the metal or ceramic particles during the formation of the melt mix.

16. The 3D metal printing process of claim 1, wherein forming of the melt mix includes loading of the metal or ceramic between 85% and 95% by weight in the composite filament mixture.

17. The 3D metal printing process of claim 1, wherein the melt mix further includes additives and/or sintering aides.

18. The 3D metal printing process of claim 17, wherein the additives include adhesion promotors for resin to metal surfaces or steric acid to increase the loading of metal particles.

19. The 3D metal printing process of claim 17, wherein the additives include plasticizers configured to add free volume to the resin and manipulate glass transition temperatures for enhanced mixing or FFF printing.

20. The 3D metal printing process of claim 19, wherein the plasticizers are selected from the group consisting of adipates, azelates, citrates, benzoates, ortho-phthalates, terephthalates, sebacates, tributyl citrate, trimellitates, and combinations thereof.
